(19) United States
(12) Patent Application Publication
(10) Pub. No.: US 2010/0138531 A1
(43) Pub. Date: Jun. 3, 2010

(54) REAL TIME PROTOCOL STREAM MIGRATION

(75) Inventor: Ashwin S. Kashyap, Plainsboro, NJ (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne- Billancourt (FR)

(21) Appl. No.: 12/452,110

(22) PCT Filed: Jun. 26, 2007
(86) PCT No.: PCT/US2007/014991

§ 371 Date: Dec. 15, 2009

(51) Int. Cl. G06F 15/173; G06F 15/16

(52) U.S. Cl. 709/224; 709/231; 709/227; 709/223

(57) ABSTRACT

A method for monitoring and migrating a primary server transmitting a real time streaming protocol (RTSP) stream is provided. Backup servers monitor at least one primary server to determining whether the primary server is active. Upon determining that a primary server is inactive, the backup servers take over the connection on which the inactive primary server was streaming data and then take over the transmission of the RTSP stream. The backup server can further derive the position in a file of the next data needed to be transmitted.

### TECHNICAL FIELD

The present principles generally relate to data streaming communications, and, more particularly, to a system and method for providing fail over capabilities of real time streaming communications.

### BACKGROUND OF THE INVENTION

Various rich media websites are increasingly providing large amounts of audio and video data over the Internet to consumers. As a result, streaming data is being transmitted over the Internet in increasingly larger quantities.

However, the nature of audio and video streaming requires a constant connection to a streaming server for audio/video playback. A real-time streaming protocol (RTSP) as described in Internet Working Group Document RFC 3550; July 2003, generally dictate that data be transferred in discrete packets, which must be delivered to a client in relatively sequential order. Additionally, should a streaming server encounter a fault that prevents the server from transmitting further stream data, the client experience will suffer degradation, stuttering, or complete display failure.

Several methods for fixing failed streaming servers based connections have been proposed. For instance, Fine-grained failover using connection migration describes a method for providing TCP fail over capabilities by routing each streaming connection through a proxy Internet protocol address. (Fine-grained failover using connection migration. Alex C. Snoeren, David G. Andersen, and Hari Balakrishnan, Proceedings of the 3rd USENIX Symposium on Internet Technologies and Systems, pages 221-232. USENIX, 2001). This method proposes that, should a data server fail, the secondary server would take over the role of the primary. However, this transfer is agnostic of the application level protocol, and frequent state synchronization may be needed, depending on the application.

One current implementation of stream migration can be seen in RealNetwork's™ Helix™ server. The Helix™ stream migration includes causing a client media player application to connect to a backup server should the initial server fail. Helix™ has some basic fail over mechanisms implemented. These fail over mechanisms, however, do not address the issue of a server going down during live streaming. The way this works is to give the client a list of backup servers, and in case a server goes down the client itself must request must request a new connection from a backup server. Therefore, if the primary server dies, it is the client's responsibility to do something with the information. However, the quality of the user experience is affected as the user can perceive the server going down, and it may take some unacceptable time before the new stream is setup due to the latencies and buffering of information received through a communication network such as the Internet.

### SUMMARY OF THE INVENTION

The present principles propose a system and method for monitoring and migrating RTSP transmissions transparently with respect to the client, independent of the client, and allowing the fail over to occur without having to implement fail over handling at the client.

According to one aspect, the present principles of real time streaming protocol (RTSP) monitoring and fail over handling are achieved by a system and method for monitoring and migrating to a backup server a RTSP stream which transmits real-time protocol (RTP) packets, comprising opening a streaming session and starting a data transfer stream from a primary server to a client, pinging the primary server by at least one backup server, and determining whether the primary server is active/inactive. Upon determining that the primary server is inactive, the method may further comprise taking over the Internet protocol (IP) address of the primary server by a backup server, looping through the open streaming sessions of the primary server, migrating the transmission control protocol (TCP) connections from the primary server to the backup server, deriving an RTP session stream state for each open streaming session, and resuming RTSP session streaming from the backup server to the client using the derived RTSP session stream state. Upon determining that the primary server is active, the method may further comprise the steps of waiting for a predetermined time; and returning to said step of pinging the primary server by at least one backup server.

The advantages, nature, and various additional features of the present principles will appear more fully upon consideration of the illustrative implementations to be described in detail in connection with accompanying drawings.

### BRIEF DESCRIPTION OF THE DRAWINGS

In the drawings, wherein like reference numbers denote similar components throughout the views:

FIG. 1 is a diagram of a real time streaming network system as known to the prior art.

FIG. 2 is a diagram of a real time streaming network system in accordance with the present principles.

FIG. 3 is a block diagram of a method for migration of a real time stream to a backup server upon primary server failure, in accordance with the present principles.

It should be understood that the drawings are for purposes of illustrating the concepts of the present principles and are not necessarily the only possible configuration for illustrating the present principles.

### DETAILED DESCRIPTION

It is known to artisans skilled in Internet communications to transmit streaming audio and video files via a real time streaming protocol (RTSP). Generally, a RTSP protocol calls for transmitting some portion of a media live file from a server at the beginning of a streaming session (with the buffering of some data from the server), and continuing to transmit the remaining data while the streaming data is displayed or otherwise used. This transmission structure allows the streaming data to be displayed as it is received at the client, in a just-in-time display architecture. However, since streaming data is sent just-in-time, i.e. it is required or used just after it is received, network lag, or a failure at the server may seriously affect the quality of the user's experience.

Accordingly, the present principles provide a system and method for monitoring streams of audio and video data transmitted via a real time streaming protocol, and seamlessly migrating streams from failed or overloaded servers to a backup server.

It is to be understood that the present principles are described in terms of RTSP stream migration on a digital communications network; however, the present principles are much broader and may include any form of data transmission on any communications network. In addition, the present principles are applicable to any data transmission system used by a computer, telephone, set top box, satellite link, etc. The present principles are described in terms of a real time data transmission system; however, the concepts of the present principles may be extended to data transmission systems.

It should be understood that the elements shown in the Figures may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor to furthering the art, and are to be construed as being without limitation to such specifically recited examples and conditions.

Moreover, all statements herein reciting principles, aspects, and implementations of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative modules embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor or element, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any networks, switches, routers, or decision blocks shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

The present principles involve maintaining information about all the active RTSP sessions and the servers that are serving them at a location accessible to a backup server. The present principles also contemplate deriving information to recreate the RTSP conversation for each session, along with the transmission control protocol (TCP) state needed to migrate each TCP connection. A heartbeat mechanism is used to keep track of servers that are active in a server pool. When there is a server outage, the failure can be detected and an IP address takeover (rollover) is performed. Using standard means, the TCP connection can then be migrated to the backup server. These steps typically take a few milliseconds to complete. The backup server can then take over for the original server and send RTSP and real time protocol (RTP) data, as a replacement for the primary server. In some useful implementations, the same media files transmitted by the primary servers will be available to the backup servers. This can be achieved by implementing a centralized storage and exporting that file system, for example using a Network File System (NFS) or other type of system or method for backing up files to networked backup servers.

Since the RTSP state may be determined by monitoring the server, the main issue is how to derive the RTP state between a server and a client. One option is to log all RTP packets that were exchanged between a server and client. However, this means updating state several times, resulting in several million transactions a second.

Implementations of the present principles of the invention may exploit the implicit time synchronization to avoid the state update between the servers. The backup servers may derive the stream state and the RTP state from a known starting time of a particular RTSP transmission. The key aspect of RTP is that an RTP data transmission is based on real time. The stream state at any given point in time is a function of time and the RTSP state. The present principles describe a method for deriving the RTP stream state.

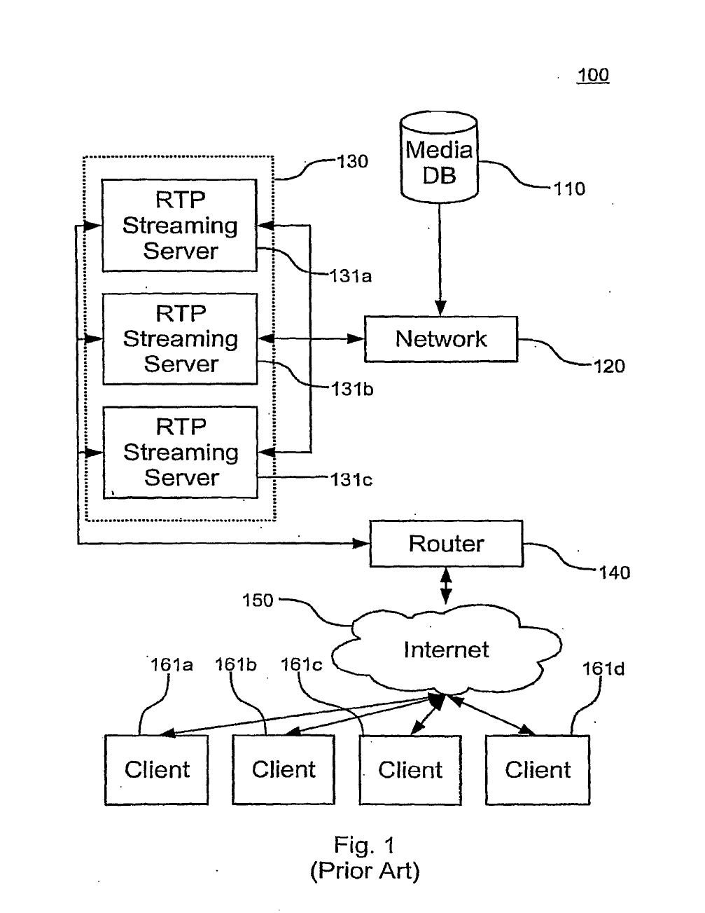

In brief description, and referring to FIG. 1, a diagram of an streaming network 100, as known in the prior art, is depicted. Initially, a server group 130 includes one or more real time protocol (RTP) streaming servers 131a-131c, where each RTP streaming server 131a-131c is connected via a network 120 to a media database 110. Media database 110 contains video and audio services capable of being transmitted over network 120 as streaming media.

The RTP streaming servers 131a-131c are connected to the Internet 150 (as a type of network) through a router 140, and through which the RTP streaming. servers 131a-131c communicate to a plurality of clients 161-161d.

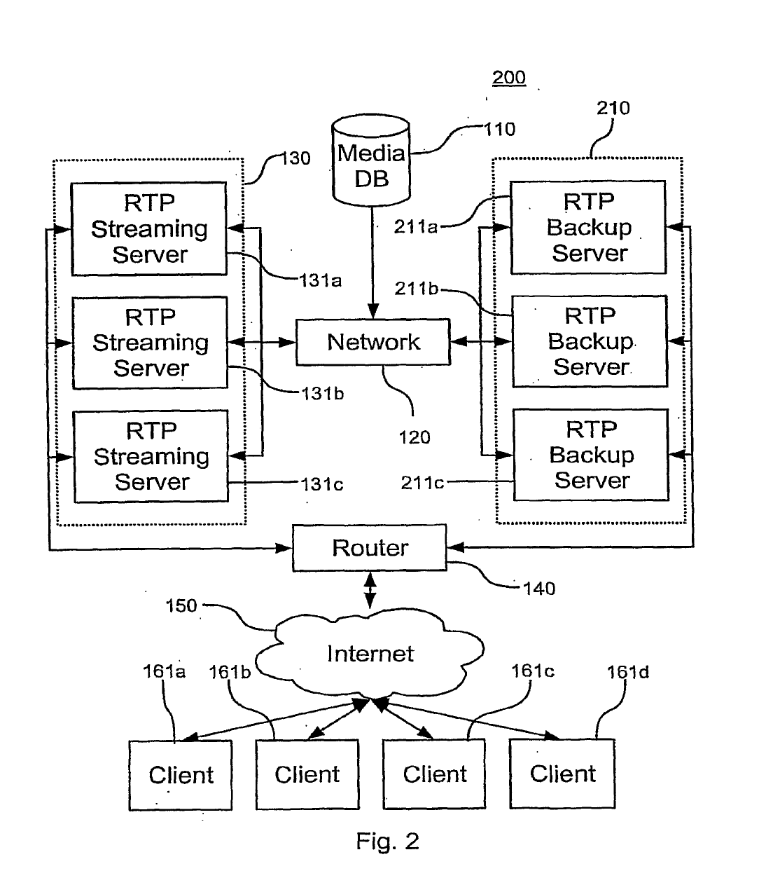

Referring to FIG. 2, a diagram of a real time streaming network system 200 in accordance with an aspect of the present principles of the invention is depicted. Initially, a server group 130, having one or more primary streaming servers 131a-131c, is connected to a network 120 through which the streaming servers 131a-131c may access a media database 110. The streaming servers 131a-131c are also connected to the Internet 150 (as a type of communications network) through a router 140, or the like through which each server 131a-131c may communicate bi-directionally to one or more clients 161a-161d.

The present principles further include backup server group 210 having a one or more RTP servers 211a-211c. Backup servers are configured to communicate through network 120 to which a coupled media database 110, such that each backup server may access the audio/video contents of the media database 110. Additionally, backup servers 211a-211c are also configured to communicate through router 140 over the Internet 150 to a one or more clients 161a-161d. Alternatively, servers 131a-131c and backup servers 211a-211c may connect to router 140, and Internet 150, through network 120. Backup servers 211a-211c may be further configured to monitor network traffic coming from each primary server 131a-131c as well. Backup servers 211a-211c may be configured to monitor and record information regarding the streaming session configuration and streaming session state. Additionally, backup servers 211a-211c may be able to communicate directly with the primary servers 131a-131c.

When implementing a network monitoring technique according to the principles of invention, a network card of each backup server 211a-211c may be set to promiscuous mode, where the network card accepts all network traffic which is transmitted to the card, instead of just the traffic addressed specifically to the network card. In this implementation, backup servers 211a-211c monitor specific primary servers 131a-131c as part of a cluster may filter any network traffic not originating from the primary servers 131a-131c that a particular backup server 211a-211c is monitoring. It should be noted, however, that any relationship between the number of backup servers 211a-211c and primary servers 131a-131c may be advantageously employed. For example, to reduce capital costs, just a few backup servers 211a-211c may monitor a large number of primary servers 131a-131c. Thus, the number of backup servers 211a-211c may be tuned to provide enough fail over capacity for a large primary server 131a-131c cluster.

This concept of the number of primary server 131a-131c versus the number of backup servers 211a-211c can be further expanded towards a situation to where different RTP streams are assigned various priorities. For example, if an RTP stream associated with a high definition video is being transmitted to a client 161a as the same time as a separate RTP stream associated low quality audio, there can be a priority where the video stream is more important than the audio stream. Hence, it is contemplated that there may be a allocation made for the type and/or content of media being delivered where higher priority media (video) is in more RTP backup servers 211a-c than low priority media (low quality audio). This priority determination can be made in of media database 110 by a party that controls both primary servers 131a-131c and backup servers 211a-c.

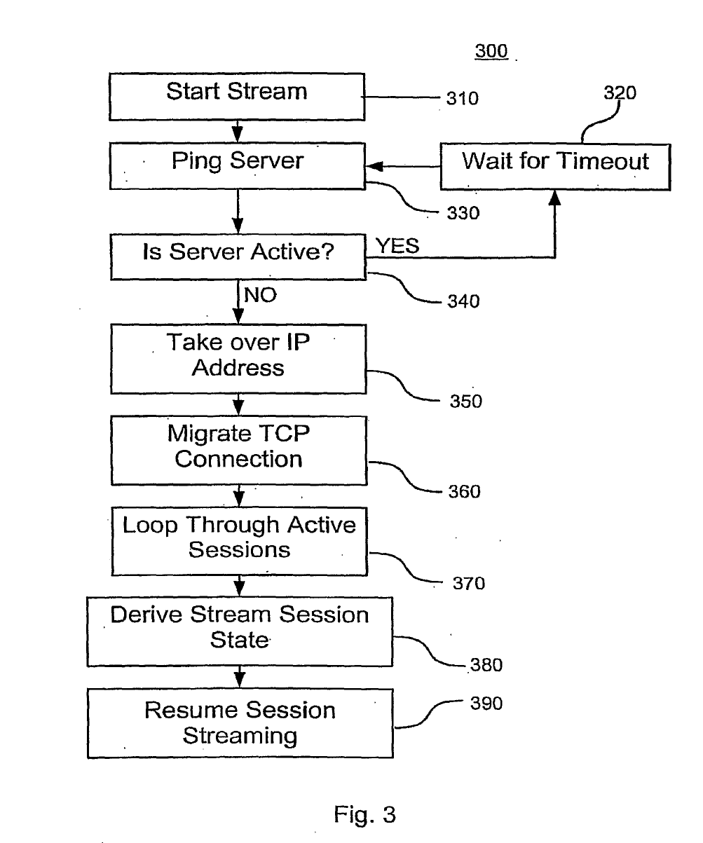

Referring now to FIG. 3, a block diagram of a method 300 for migration (transfer) of a real time stream to one or more backup server 211a-211c upon a failure of a primary server 131a-131c, in accordance with an aspect of the present principles, is shown.

Initially, an RTP stream is started in block 310. In one useful implementation, the primary servers 131a-131c will start a new session with client 161a-161d. This session may advantageously be initiated by client 161a-161d request, by a predetermined condition being met, or by any other means known or as yet undiscovered. For example, client 161a-161d may request a video from a recent television show by clicking on a hyperlink embedded in a web page. A user interface may then be displayed at client 161a-161d allowing a user to control the display of the streaming media. For example, after clicking a link, a client may open a media player with a media display area and associated controls including a play button, pause button, media clip timeline, and the like. Such interfaces are known and will be familiar to skilled artisans.

Upon loading the appropriate user interface, the data transfer starts in block 310. In one useful implementation, the data transferred from server 131a-131c to client 161a-161d may be buffered for some short time at client 161a-161d before being displayed. For example, when the user clicks a link to display a streaming media file, the media file is opened in a media player interface. The media player then connects to server 131a-131c, requesting the desired file. After the server acknowledges the request, server 131a-131c begins sending data packets containing media information to the client, which are then displayed. The negotiation of the streaming session is considered part of starting the streaming session. Likewise, the RTSP state is changed to play to begin the media playback, whether initiated automatically, or upon the user clicking a play button, or the like.

In order to properly track each session, several pieces of information must be stored and available to any backup servers 211a-211c, including, but not limited to:

The Sending Source identifier (SSRC) as used in the RIP header;

The payload type;

The location of the resource being streamed (URL);

The server and client port numbers over which the data is being streamed;

The sequence number of the first RTP packet after the RTSP state was changed to play;

The time stamp of the first RTP packet after the RTSP state was changed to play;

The network time (WT) when the RTSP state was changed to play;

The network time when then streaming session started.

This information may, among other methods, be communicated to backup servers 131a-131c by saving the information in common network location that is accessible to backup servers 211a-211c, by transmitting the information directly to backup servers 211a-211c, or by backup servers 211a-211c monitoring the network traffic of primary servers 131a-131c.

Additionally, in order to accurately calculate the migration (transfer) of a streaming session, all of the primary servers 131a-131c and backup servers 211a-211c may use the same time basis to calculate any network times or timestamps. In one useful implementation, the internal clocks of the primary servers 131a-131c and backup servers 221a-221c may be coordinated using the network time protocol (NTP) over the network 120.

After the data stream is started in block 310, then the backup server 211a-211c ping the primary servers in block 330. While the term ping can be used to mean a simple Internet Control Message Protocol (ICMP) echo request that allows a pinging server to verify that the target server is responding, the term ping, in this case, is intended to include any form of server activity verification. In one useful implementation, each primary server may broadcast a heartbeat signal addressed to one or more backup servers 211a-211c. In another useful implementation, the ping would be a small request that requires little or no processing on the part of the target server 131a-131c. However, a simple ping such as an ICMP echo request only verifies that the server is responding. While this may be helpful to verify that a primary server 131a-131c is handling traffic, it would not allow the verification of the server being under a load server 131a-131c is capable of handling. In such a case, the ping may be, but is not limited to, for instance, a request for an actual media clip or other resource from primary server 131a-131c, with the requesting server measuring the response time, or may be a request where the primary server 131a-131c responds with a status code indicating whether the server is currently running properly, or is overloaded. It is to be understood that the term ping also represents a status message indicating whether a server is active or inactive.

In another useful implementation, every backup server may ping (communicate) with every primary server at regular intervals to ensure that all of the primary servers are operating normally. However, as the number of primary servers 131a-131c and the number of backup servers 211a-211c increases, the total number of ping requests increases exponentially. Therefore, in yet another useful implementation, primary servers may be grouped into clusters, with an associated cluster of backup servers 211a-211c. For example, in a data center with 1000 primary servers 131a-131c, and 500 backup servers 211a-211c, 4 primary servers may be clustered together, and may be monitored by 2 backup servers. Thus, within each cluster, only 8 ping requests occur each time servers are pinged in block 330 (with each backup server in the cluster pinging each primary server in the cluster). With 250 such clusters, the entire network load for pinging servers in block 330 Would only be 2000 ping requests. Conversely, if all 500 of the backup servers monitored all 1000 of the primary servers on such a network, 500,000 ping requests would be necessary each time the servers were pinged in block 330. While the present example uses clusters of 2 backup servers 211a-211c monitoring a cluster of 4 primary servers 131a-131c, any number or configuration of backup servers 211a-211c and primary servers may be used as redundancy needs and network architecture dictate.

Alternatively, when primary servers 131a-131c utilize a heartbeat signal, each primary server 131a-131c may transmit a heartbeat signal at regular intervals in block 330 across the network 120, where the heartbeat signal may be received by backup servers 211a-211c monitoring the primary server 131a-131c data traffic over network 120 or router 140.

Backup servers 211a-211c would then determine, in block 340, whether each primary server 131a-131c was active/inactive. In one useful implementation, the backup servers may measure the time period needed to receive a response to the ping sent to each primary server 131a-131c in block 330. Should the ping response not be received within a specified time period, the backup servers 211a-211c may determine that the primary server 131a-131c being analyzed is not active, and then migrate the RTSP stream sessions of the failed primary server 131a-131c to backup server 211a-211c. Alternatively, in another useful implementation, primary server 131a-131c being analyzed may return a response to the ping indicating that primary server 131a-131c is overloaded, or that the server has experienced some sort of unrecoverable hardware or software failure. In such a case, the backup server 211a-211c may also determine that the primary server 131a-131c is no longer active in block 340.

Conversely, should primary server 131a-131c send an appropriate response, or a response within an acceptable time frame to the backup servers 211a-211c, then backup servers 211a-211c may determine that the primary server is active in block 340.

If backup servers 211a-211c determine in block 340 that the primary server 131a-131c is active, then the process checking for server activity will wait for some specified timeout in block 320 before beginning the ping process in block 330 again. In particularly useful implementations, the duration of the timeout on block 330 will be short enough to allow a failover to backup server 211a-211c to occur without degrading the user experience.

However, should a server be determined to not be active in block 340, then the backup server 211a-211c would migrate the RTSP streaming sessions of the failed primary server 131a-131c to backup server 211a-211c by initially taking over the Internet protocol (IP) address of the failed primary server 131a-131c in block 350, and migrating the active TCP connections in block 360. The IP address takeover in block 350, and TCP connection migration in block 360 are well known to those skilled in the art of data communications, and will be familiar to those artisans. In practice, such IP address takeover in block 350 and TCP connection migration in block 360 takes only a few milliseconds to accomplish. This allows a backup server 211a-211c to impersonate the original, now failed, primary server 131a-131c.

Backup server 211a-211c would then, in block 370, loop through all of the active RTSP streaming sessions for failed primary server 131a-131c, and for each active streaming session encountered in block 370, the backup server will derives a session state in block 380. The derivation of the session state in block 380 makes use of information collected when the stream was started in block 310. By using such information with the latest known information about the state of the stream gathered from monitoring the primary server 131a-131c prior to failure, the backup server may derive the next data packets that need to be sent to the client 161a-161c. In one useful implementation, the following function may be used to derive the stream state:

SN(X)=SN+(X−SNM) [1]

where X represents the index of the media sample in a media file. that needs to be transmitted to the client 11a-161c next. SN(X) is the current sequence number to be put into the RTP packet, SN is the sequence number of the first RTP packet after the RTSP stream state was changed to play, and SNM is the index of the media sample in the RTP packet when the RTSP stream state was changed to play. Therefore, (X−SNM) represents the number of samples since the RTSP stream was changed to play.

X may be determined from:

TS(X)=TS(SNM)+D [2]

where TS(X) is the time stamp of X, TS(SNM) is the time stamp of SNM, and D is the time elapsed since the RTSP state was changed to play. D may be calculated by:

D=t−WT [3]

where ‘t’ is the current network time, and consequently roughly approximates the time the primary server 131a-131c failed, and WT is the network time that the RTSP session state changed to play, and was recorded in block 310, then the stream started.

Therefore, D represents the total elapsed time that media samples were transmitted prior to the primary server 131a-131c failure. TS(SNM) represents the time stamp of the first RTP packet sent when the RTSP was changed to play, and is used as an initial offset to calculate the currently needed time stamp of X (TS(X)).

The sequence number of X, (SN(X)), is calculated separately. Using the time stamp calculated for X, (TS(X)), the backup server 211a-211c may move the media file read pointer to the location of sample X in the media file, where sample X has the timestamp TS(X). The backup server may then find the serial number of X. The serial number of the first RTP packet (SN) is used as the initial offset for the entire stream, to which the sequence number of the current sample in the current media file (X−SNM) is added.

By using an offset for the entire streaming session as well as the offset for the media file, multiple media files may be sequentially streamed in a single session, and the method 300 may handle, the failure during playback of a media file subsequent to the first media file.

Once the stream session state is derived for each active session in block 380, the backup server transmits the needed media sample in block 390, using the IP address taken over in block 350, and over the TCP connection migrated in block 360.

Having described preferred implementations for a system and method for monitoring a streaming server (which are intended to be illustrative and not limiting), it is noted that modifications and variations can be made by persons skilled in the art in light of the above teachings. It is therefore to be understood that changes may be made in the particular implementations of the present principles disclosed which are within the scope and spirit of the present principles as outlined by the appended claims. Having thus described the present principles with the details and particularity required by the patent laws, what is claimed and desired protected by Letters Patent is set forth in the appended claims.

1. A method for monitoring and migrating a real time streaming protocol (RTSP) stream transmitting real-time protocol (RTP) packets to a backup server, the method comprising:
opening a streaming session and starting a data transfer stream from a primary server to a client;
pinging the primary server by at least one backup server;
determining whether the primary server is active/inactive, wherein upon determining that the primary server is inactive:
taking over the Internet protocol (IP) address of the primary server by a backup server;
looping through at least one open streaming session of the primary server;
migrating the transmission control protocol (TCP) connection from the primary server to the backup server;
deriving an RTP session stream state for each open streaming session; and
resuming RTSP session streaming from the backup server to the client using the derived RTSP session stream state.

2. The method of claim 1, wherein, upon determining that the primary server is active:
waiting for a predetermined time; and
returning to said step of pinging the primary server by at least one backup server.

3. The method of claim 2, wherein said opening further comprises:
determining and making available by the primary server to the backup servers, a sequence number of the first RTP packet after the RTSP state was changed to play;
determining and making available by the primary server to the backup servers, a time stamp of the first RTP packet after the RTSP state was changed to play;
determining and making available by the primary server to the backup servers, a network time when the RTSP state was changed to play; and
determining and making available by the primary server to the backup servers, a network time when then streaming session started.

4. The method of claim 3, wherein said deriving further comprises:
determining a sequence number of for RTP packet having a media sample in a media file; and
moving a file read pointer for the media file to the location of the media sample to be transmitted based on the timestamp of the media sample;

5. The method of claim 4, wherein the determining of a sequence number comprises:
subtracting an index of a media sample in an RTP packet when the RTSP state was changed to play to determining the number of media packets transmitted; and
determining the sequence number of an RTP packet having a media sample to be transmitted next by adding the number of transmitted media packets to the sequence number of the first RTP packet after the stream state changed to play.

6. The method of claim 4, wherein said moving a file read pointer comprises:
calculating an elapsed time since the RTSP state was changed to play (the elapsed time) by subtracting the network time that the RTSP session state changed to play from the current network time;
calculating the timestamp of the media sample to be transmitted by adding the elapsed time to the timestamp of a sample in the media file in the first RTP packet when the RTSP stream state was changed to play;
moving a file read pointer for a media file to the file location of a media sample having a timestamp equal to the timestamp of the media file to be transmitted.

7. The method of claim 1, wherein said pinging comprises:
sending out a heartbeat message from the primary server; and
waiting for the heartbeat message at the at least one backup server, the backup server determining whether the primary server is active/inactive by the failure to receive the heartbeat message within a predetermined time.

8. The method of claim 1, wherein the pinging comprises:
monitoring network traffic of the primary server at the at least one backup server, the at least one backup server determining whether the primary server is active/inactive by the failure of the backup server to detect any network traffic from the primary server within a predetermined time.

9. The method of claim 1, further comprising monitoring a plurality of primary server clusters having a plurality of primary servers by a plurality of backup server clusters having plurality of backup servers, each backup server cluster monitoring one primary server cluster.

10. The method of claim 1, further comprising synchronizing the internal clocks of the primary servers and the backup servers to a common network time using the Network Time Protocol (NTP).

11. A method for monitoring comprising:
transmitting a status query message from to a first server from a second server after a streaming session is started with a client;
repeating the transmission of said status query message after a period of time when said status message from said first server indicates that said first server in an active state until at least one of: said streaming session is terminated with said client and said status message indicates said first server is inactive;
transmitting data to said client from said second server, representing said streaming session, when said first server is reported as inactive.

12. The method of claim 11, wherein said streaming session is a real time streaming protocol (RTSP) streaming session transmitting real-time protocol (RTP) packets.

13. The method according to claim 12, wherein, upon determining that the first server is inactive:
said transmitting step comprises replacing the RTSP streaming session of the first server with an RTSP streaming session originating from said second server.

14. The method of claim 13, wherein said migrating comprises:
taking over the Internet protocol (IP) address of the first server by said second backup server;
migrating the transmission control protocol (TCP) connection from the primary server to the backup server;
looping through at least one open streaming session of the first server;
deriving an RTSP session stream state; and
resuming RTSP session streaming from the second server to the client using the derived RTSP session stream state.

15. The method of claim 14, wherein a plurality of primary server clusters having a plurality of primary servers, wherein one of the primary servers is said first server, are monitored by plurality of backup server clusters having plurality of backup servers, wherein one of the backup servers is said second server and a backup server cluster monitors at least one primary server cluster.

16. The method of claim 14, wherein said first server and second server have internal clocks which are synchronized to a common network time using the Network Time Protocol (NTP).

17. A system for monitoring and migrating a real time streaming protocol (RTSP) stream transmitting real-time protocol (RTP) packets, comprising:
a media database configured to transmit media files over a network;
at least one primary server configured to:
accept media file requests from at least one client;
retrieve media files from the media database over the network; and
open a streaming session and start a transfer of the requested media file from the primary server to the client;
at least one backup server configured to:
monitor the at least one primary server;
determine if each of the at least one primary servers are active/inactive; and
migrate the RTSP streams of a primary server upon the backup server determining that the primary server is inactive.

18. A program storage device having an application program tangibly embodied thereon, the application program including instructions for performing at least the following:
pinging a primary server;
determining whether the primary server is active/inactive;
upon determining that the primary server is active:
waiting for a predetermined time; and
repeating said step of pinging the primary server by at least one backup server; and
upon determining that the primary server is inactive:
migrating at least one streaming session of the failed primary server to a backup server.

19. The program storage device of claim 18, wherein the instructions for performing said migrating step further comprises instructions for:
migrating at least one real time streaming protocol (RTSP) streaming session of the failed primary server to the backup server.

20. The program storage device of claim 19, wherein the instructions for performing said migrating step further comprise instructions for:
taking over the Internet protocol (IP) address of the primary server;
migrating the transmission control protocol (TCP) connection from the primary server;
looping through at least one open streaming session of the primary server;
deriving an RTSP session stream state; and
resuming RTSP session streaming using the derived RTSP session stream state.

21. The program storage device of claim 18, wherein the instructions for performing said determining step further comprise instructions for:
listening for a heartbeat signal from the primary server; and
determining whether the primary server is active/inactive by the failure of the to receive the heartbeat signal within a predetermined time.
